(19) United States
(12) Patent Application Publication
(10) Pub. No.: US 2002/0178213 A1
(43) Pub. Date: Nov. 28, 2002

(54) Remote URL munging

(76) Inventor: John Chad Parry, Idaho Falls, ID (US)

Correspondence Address: LYON & LYON LLP, 633 WEST FIFTH STREET, SUITE 4700, LOS ANGELES, CA, 90071, US

(21) Appl. No.: 09/829,951

(22) Filed: Apr. 11, 2001

(51) Int. Cl. G06F 15/16; G06F 17/00

(52) U.S. Cl. 709/203; 707/513

(57) ABSTRACT

A business method for providing a remotely hosted service by an application service provider (ASP) wherein the hosted service is seamlessly integrated into a customer document at a user location. One embodiment of a system for providing the business method includes a combination of novel JavaScript technology and URL munging. For example, an administrative interface may facilitate the insertion of a line of static JavaScript code into a customer's Web page. The code may interpret a munged URL and pass the munged URL to an ASP server. An ASP server may extract session variables that were encoded in the munged URL. The ASP server may generate a dynamic JavaScript program that displays the hosted service, e.g., a hosted site search engine. The hosted service may thereby be written directly into the customer's Web page so that the Web user is not aware that the service is hosted remotely.

### BACKGROUND OF THE INVENTION

1. Field of the Invention

This invention relates generally to systems and methods for managing session data of a network client. More specifically, the invention relates to business methods and systems for managing session data using Universal Resource Locator munging.

2. Background

The invention concerns interactive network services, such as a hosted site search engine. A hosted site search engine enables World Wide Web users to execute a keyword search on the content found on a particular Web site. To use a site search engine, a Web user must decide on a few keywords that represent the content he or she is looking for. These keywords are entered in a search query. Search queries can also take the form of questions or even of complex logical expressions.

Site search engines differ from general World Wide Web search engines found on Internet portals like Yahoo! or AltaVista. General search engines search the entire World Wide Web. In contrast, site search engines search only the pages published at a particular Web site and ignore the rest of the World Wide Web. Web surfers find site search capabilities useful in quickly locating content of interest at a particular Web site. Web site owners prefer site search searching over general Web searching because a site search does not return search results that lead a surfer to competitors' Web sites. Using a site search engine, Web surfers are more likely to find content of interest before moving on to other sites. Thus, site searching may increase the amount of time a Web surfer spends at a particular site.

Search engines are complex systems comprising both hardware and software components. Because of this complexity, search engines are very expensive to build and to maintain. In fact, developing in-house site search engine technology is prohibitively difficult for many small-sized web sites, and many medium-to-large-sized Web sites struggle with providing these services cost-effectively. Many Web developers would welcome a site search engine of their own, but lament that they don't have the resources to provide this service to site visitors. Consequently, many Web developers look to external search engine vendors for help.

Site search engine vendors presently use at least two distribution models for their services. In a first model, a vendor sells search engine software or software licenses to its customers. Customers must install the software on an Internet server and must then maintain both the software and server hardware throughout the life of the product. In a second model, a vendor provides search engine services online as an application service provider (ASP). In this second model customers do not have access to the site search engine software. Instead, the ASP guarantees the availability of the services, eliminating the need for the customer to install or maintain anything. This second model is commonly called a “hosted site search engine.”

The hosted site search engine model comprises three entities: an application service provider (ASP), a customer that obtains searching capabilities or other Web tools from the ASP, and a Web surfer or user that visits the customer's Web site. Throughout this specification these entities will be referred to as an ASP, a customer, and a user, respectively.

Historically, one of the disadvantages of hosted site search engines is that service Web pages and data reside on a remote vendor server. This arrangement makes it difficult for the customer to customize the searching services because any changes to the searching service must be uploaded to the ASP's server with the vendor's approval. In addition, when a user is using this type of service the user's browser is automatically directed to leave the customer's Web site in order to visit the ASP's Web site and execute the search This forced redirection has long been viewed as a branding disadvantage to the customer because the address of the customer's Web site no longer appears in the location bar of the user's browser while the user is accessing the hosted service at the ASP web site.

For several years now business methods employed by ASPs have tried to disguise the fact that the user is leaving the customer's Web site in order to perform the search. ASPs have tried to make their hosted services appear to be an integrated part of the customer's Web site, but none have been fully successful.

Therefore, it is desirable to provide a system and method for a hosted site search engine or other interactive service that is seamlessly integrated into a customer's Web site and does not require the user to leave the customer's Web site.

It is further desirable to provide a system and method for a hosted site search engine or other interactive service that is seamlessly integrated within the customer's own branded Web pages by merging hosted service data within customer Web page data at the user browser.

Additionally, it is desirable to provide a method of doing business wherein an application service provider is enabled to distribute to customers a hosted service that may be easily and economically integrated into a customer's Web site without burdensome development, installation, and maintenance.

### BRIEF DESCRIPTION OF THE DRAWINGS

FIG. 1 is a diagram of the data flow within an on-site application service;

FIG. 2 is a diagram of the data flow within an off-site application service;

FIGS. 3A and 3B are diagrams of the data flow within an embodiment of the present invention that uses, for example, remote URL munging;

FIG. 4 is a screen shot of a hosted service results page according to one embodiment of the present invention;

FIGS. 5A-C are diagrams of the data flow within another embodiment of the present invention that uses, for example, cookies;

FIG. 6 is a screen shot of an administrative interface comprising a login page according to one embodiment of the present invention;

FIG. 7 is a screen shot of an administrative interface comprising customization tools according to an exemplary variation of the present invention;

FIG. 8 is a screen shot relating to an indexing spider according to one embodiment of the present invention; and

FIG. 9 is a screen shot of a search report according to an exemplary variation of the present invention.

### SUMMARY OF THE INVENTION

The invention comprises a Web development tool and business method for Web site managers. In one embodiment of the invention this tool comprises a hosted site search engine. In a preferred embodiment of the invention, an Application Service Provider (ASP) distributes the tool online using servers controlled by the ASP. Source code and object code for the invention are not accessible to anyone except for ASP employees. Customers are charged a monthly subscription fee for the service. The monthly fee depends on the amount of computing resources consumed by the particular customer's usage. Several product types of varying complexity are available to customers.

The inventive systems and methods are easier to use and offer a higher degree of customization than other known application service products. Customers may incorporate site search capability into any Web page by simply copying and pasting HyperText Markup Language (HTML) code into the Web page. This is a significant advantage over other known installation procedures, some of which require up to sixteen hours. Further, the inventive systems and methods allow the seamless integration of search results with a customer's own branded Web pages. In one embodiment of the invention, XHTML technology gives a customer powerful product-specific search capabilities.

In a preferred embodiment of the invention, a combination of novel JavaScript technology with Uniform Resource Locator (URL) munging allows a hosted service, such as a hosted site search engine, to be easily and seamlessly integrated into a customer's Web site. In this embodiment, static JavaScript code is inserted into the customer's Web page. This code executes a second JavaScript program that passes a “munged” URL to the ASP's servers. The ASP's servers then parse the session variables that were encoded in the munged URL. Finally, the ASP's servers generate a dynamic JavaScript program that displays the hosted service (e.g., a search form) directly within the customer's Web page. As a result, the Web user is unable to discern that the services provided using this technique are hosted remotely.

The invention provides a cost-effective solution to Web developers by reducing development, installation, and maintenance costs while retaining a high level of customization. While a preferred embodiment of the invention presented herein contemplates usage in a hosted site search engine environment, the invention is not so limited. The invention may be practiced with other application services, as will occur to a person of skill in the art from the detailed description below.

### DETAILED DESCRIPTION OF THE INVENTION

The invention may best be understood by a description of various methods used to provide services such as search engine services to Web site customers over the Internet. The differences between the methods are best understood by an analysis of their respective data flow characteristics.

On-site Method

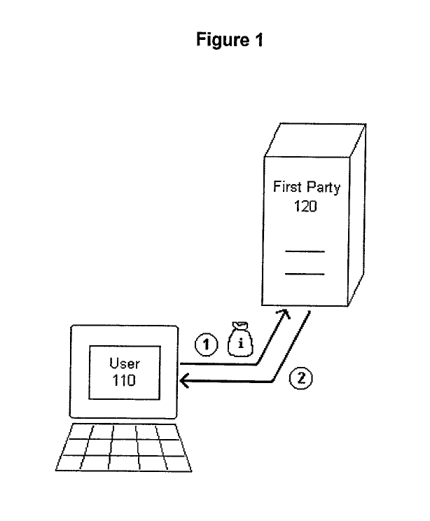

In the on-site method, a first party uses its own servers to provide the service, for example, a site search engine service. A diagram representing the data flow in the on-site method is shown in FIG. 1. Each of the circled numbers in FIG. 1 corresponds to a numbered step below. The lines in FIG. 1 represent lines of communication. The arrows show the direction in which data travels.

1. Web user 110 makes a request for a Web page from the first party's systems 120, for example, a Web server. In step 1, dynamic information “i” may be encoded into a query string, a cookie, or a Hypertext Transfer Protocol (HTTP) message body and passed from user 110 to first party server 120 along with this request. Dynamic information may include the keywords being searched or unique identification of the Web user.

2. At step 2, first party server 120 responds to the user's request by creating a Web page that embodies the requested service. Server 120 sends this Web page to user 110.

This process may be repeated several times as user 110 downloads different information from the first party's server 120. For example, user 110 may click on a text link that says, “Search This Site” in step 1. The user's browser will then send a request for a Web page associated with the text link. In step 2 server 120 will return a Web page that contains a search form. User 110 then fills out the search form by entering a search query. User 110 then clicks a button that is labeled, “Submit”. By clicking this button, user 110 requests a new Web page from server 120. This represents a return to step 1. The new Web page may be a Web page containing search results. Dynamic data, such as form variables or individual identification in the form of cookies, can be passed to server 120 along with this request. The first party's server 120 then responds in step 2 with search results that are tailored for the individual user based on the transmitted user input.

While some Web site owners develop their own search engines that use the first-party method, other Web site owners choose to license search engine technology from an external developer. In either case, the Web site owner is here referred to as the first party. In the latter case, the first party negotiates a license with the external developer. The external developer then provides the first party with the executable code for a site search engine. The executable code is installed on first party server 120. The first party is then responsible for the maintenance of both the software and the hardware running the search engine.

Off-Site Method

In the off-site method, a user is directed “off-site” to obtain a hosted service, for example, a search engine service. In this case, the user is sent to a hosted service provided by the ASP's server instead of the customers server. For example, the user may view search results on a Web page that is generated by and provided by the ASP. As such, the user computer is redirected from a customer's Web site to an ASP's Web site; the location bar of the user's Web browser shows the URL of the ASP's Web site, not the customer's Web site.

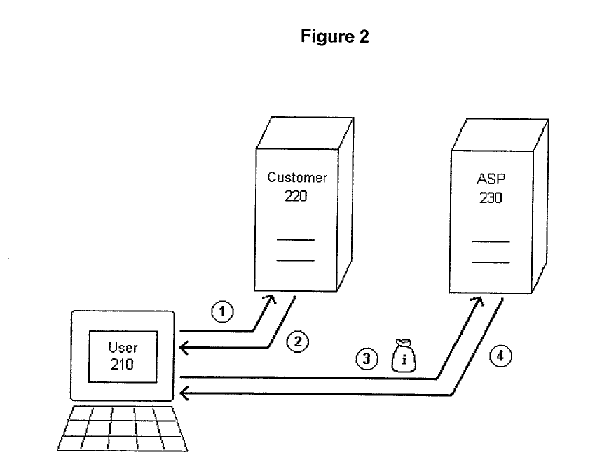

The data flow of the off-site method is shown in FIG. 2. Each of the circled numbers in FIG. 2 corresponds to a numbered step below. The lines in FIG. 2 represent lines of communication. The arrows show the direction in which data travels.

Downloading a Service Request Form

1. User 210 makes a request for a Web page from customer system 220. For example, user 210 may click on a text link that says, “Search This Site” in step 1. User system 210 may then send a request to customer server 220 for a Web page associated with the link.

2. Customer server 220 responds with a Web page. This Web page may be static. Server 220 returns a Web page that contains a search form. The “Submit” button on the search form returned by server 220 is linked to a URL at ASP server 230, not to a URL at customer server 220. For example, customer server 220 references the ASP Web site on ASP server 230 by using an HTML form that directs data entered into the fields of the form to be submitted to the service residing on ASP server 230.

Requesting a Service

3. User 210 fills out the search form by entering a search query. User 210 then clicks on a button that is labeled, “Submit.” The action initiated by clicking “Submit” on this form differs from the on-site method. Instead of requesting a new Web page from server 220, the “Submit” button in this case has been coded to request a Web page from ASP server 230. In step 3, dynamic information “i” is encoded into a query string, a cookie, or an HTTP message body and then passed to ASP server 230 along with this request. Dynamic information may include the keywords being searched or unique identification of the Web user.

Downloading the Service Results

4. Server 230 responds to the user's request by creating a Web page that embodies the requested service. Server 230 sends this Web page to user 210. For example, this Web page may contain search results that are tailored for the individual user based on the transmitted user input.

Although the following preferred embodiments of the invention describe a hosted site search engine, one skilled in the art will recognize that the type of service provided by the present invention is not limited to a search engine service. Further, the invention is not limited to the exemplary search requests described herein. As will occur to one of skill in the art, service requests other than search requests may be implemented using the inventive systems and methods.

Remote URL Munging

The Remote URL Munging method may best be understood by a description of the interaction and data flow between a Web user, a customer and an ASP. While the following description details actions that a Web user may perform, these actions may be performed automatically by a computer and may even be hidden from the human user.

In one embodiment, the present invention uses URL munging to encode session data in the URL of a Web page. Session data serve the dual purpose of preserving state information and uniquely identifying individual Web users. URL munging provides similar functionality to “cookies,” another form of session data management known in the art. Some Web users perceive cookies as an invasion of privacy because this method of session data management often stores data to and retrieves data from a Web user's hard drive without the user's knowledge. URL munging does not carry this privacy invasion stigma. By using remote URL munging, a customer or an ASP may advertise that the hosted service is provided without the use of cookies. Some ASPs and customers will find this ability to be a competitive advantage.

URL munging is the process by which session variables are encoded and appended to a URL. These session variables may include a unique identifier of the specific Web user, profile information about that user, and the specific information requested by the user. A user's Web browser provides these session variables to a Web server when the user's browser is requesting a Web page. The Web server can then use those variables to dynamically generate a Web page that is tailored for that individual user at that specific time. “Munging” refers to the changes that are made to a URL when these session variables are added to it. An Internet server other than the server requested in the URL can perform remote URL Munging.

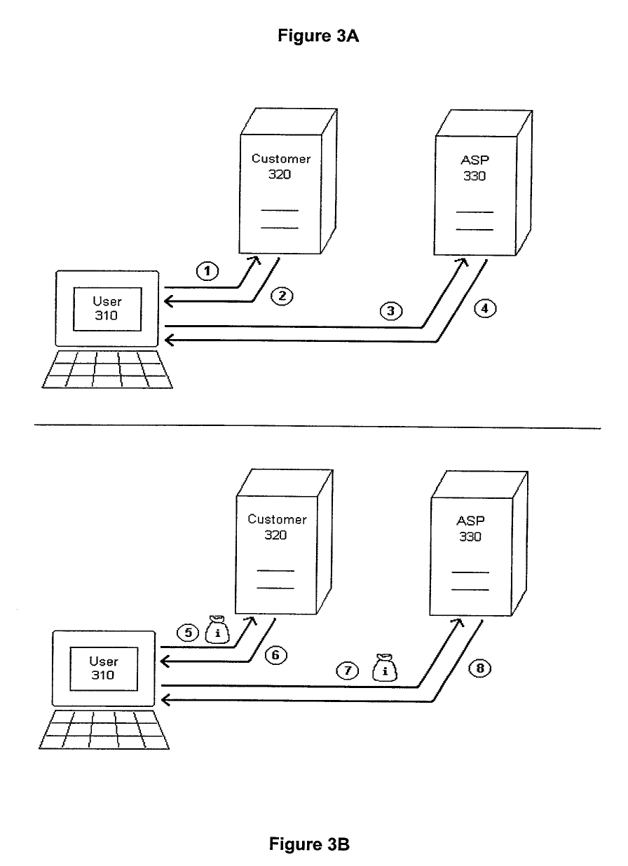

FIGS. 3A and 3B illustrate the flow of data in one embodiment of the invention that uses remote URL munging. Each of the circled numbers in FIG. 3 corresponds to a numbered step below. The lines in FIG. 3 represent lines of communication. The arrows show the direction in which data travels.

Downloading a Service Request Form

1. User 310 sends a request for a customer document, for example, a Web page, from customer server 320. For example, the user 310 may click on a text link that says, “Search This Site” in step 1. User browser 310 may then send a request to customer server 320 for a Web page associated with the link.

2. Customer server 320 may then respond with a Web page. This Web page may be static and may have embedded within in its source an instruction for user browser 310 to import a service resource from ASP server 330. This instruction replaces the search form in step 2 of the off-site method. This instruction may be, for example, an HTML script tag that instructs user browser 310 to import a JavaScript source file from ASP server 330. This resource may be retrieved from a local cache rather than downloaded from customer server 320.

3. As user browser 310 is interpreting the Web page of step 2, user browser 310 encounters the instruction to import a service resource from ASP server 330. This instruction may be, for example, an HTML tag that causes a JavaScript source file to be imported from ASP server 330. When user browser 310 encounters this instruction, user browser 310 immediately requests a service resource from ASP server 330. In a preferred embodiment, the requested service resource may be a JavaScript resource. The third arrow in FIG. 3 represents this request. Static information may be sent along with this request. Static information may include, for example, a customer identifier or a code indicating the type of service that is being requested.

4. Upon receiving the request of step 3, ASP server 330 creates a service resource. This service resource may be, for example, a JavaScript source file. The service resource may display hosted application service information directly into the Web page downloaded in step 2. In various embodiments of the invention, this information may comprise a customized splash screen, default information, an HTML search form, and/or a poll or questionnaire. For example, this information may include a search form with a “Submit” button that is linked to customer server 320.

Requesting a Service

5. User 310 may enter information to be submitted to the customer Web site. For example, user 310 may fill out the search form by entering a search query to be submitted to the customer Web site. User 310 then initiates an action to send the search query. For example, this action may be the click of the “Submit” button. In this case, the action initiated by clicking “Submit” on this form has been coded to request a Web page from customer server 320. In step 5, dynamic information “i” may be munged and passed to customer server 320 along with this request. Dynamic information may include, for example, the keywords being searched or unique identification of the Web user. Thus, the URL that is requested when user 310 clicks the “Submit” button is a URL that may be munged with dynamic information “i,” i.e., dynamic information has been appended or otherwise added to the URL being requested.

6. Customer server 320 responds to the request in step 5. Customer server 320 need only recognize the static portion of the URL and need not process the data that was munged. Customer server 320 may then respond to the request in step 5 by transmitting a Web page to user 310. The Web page may have an instruction embedded within its source code that instructs user browser 310 to import a service resource from ASP server 330. For example, this instruction may be an HTML script tag that instructs user browser 310 to import, for example, a JavaScript source file from ASP server 330.

Downloading the Service Results

7. As user browser 310 is interpreting the Web page of step 6, user browser 310 encounters the instruction to import a service resource from ASP server 330. In one embodiment of the invention, this instruction is an HTML tag that causes a JavaScript source file to be imported from ASP server 330. As in step 3, when user browser 310 encounters this instruction, user browser 310 immediately makes a request for a service resource on ASP server 330. The service resource requested may be, for example, a JavaScript resource. Step 7 in FIG. 3B represents this request. The instruction in step 7 may further direct user browser 310 to extract session data that was munged into the URL of the Web page sent in step 6 and send that session data to ASP server 330 with the Web page request. The session data may be sent to ASP server 330 using, for example, a query string.

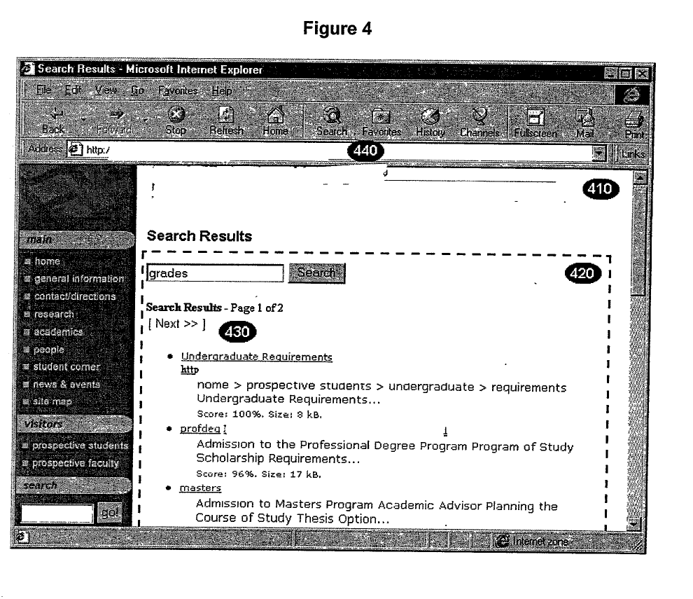

8. ASP server 330 may use the session data that was sent to it in step 7 to determine the status of user 310 and to provide an interactive service, for example, to provide search results from terms specified by user 310. Upon receiving the request of step 7, ASP server 330 may create a service resource, similar to step 4 above. This service resource may be, for example, a JavaScript source file. ASP server 330 may respond to the user's request in step 7 by sending this file. The service resource displays hosted application service information directly within the Web page downloaded in step 6. This file may contain new information not sent to the user in step 4. The result of the method may be, for example, a customer Web page into which search results have been seamlessly integrated, as shown in FIG. 4.

In one variation of the invention, user 310 need not request a customer document from customer server 320 in step 5. In such a case, dynamic information is sent directly to ASP server 330, not to customer server 320. ASP server 330 may then respond with a service resource, as in step 8. Intermediary requests of the customer server 320 may be avoided. Instead of customer server 320 transmitting a document as in step 6, hosted application service information may be displayed directly into the customer document that may have been loaded in step 2.

As noted above, the Web page provided by the customer server 320 in steps 2 and 6 may include an instruction embedded within its source code that directs user browser 310 to import a JavaScript source file from ASP server 330. In one embodiment of the invention, ASP 330 distributes the code for this instruction to customer 320 using, for example, the business method described below. The functionality of the embedded instruction (e.g., an HTML script tag) and its relationship to the service resource (e.g., a JavaScript program on ASP server 330) will now be discussed in greater detail.

HTML and JavaScript Embodiment of URL Munging Method

Table 1 provides an example of an HTML script tag that may be used with the present invention. The HTML script tag in Table 1 causes user browser 310 to import a JavaScript program from ASP server 330. This import action is triggered by the “src” attribute of the script tag. The behavior of the “src” attribute is defined by the HyperText Markup Language (HTML) 4.01 Specification.

TABLE 1
Example HTML Script Tag

<script
src=“http://my.jittersearch.com/import.js?username=cswww&form=Standard&results=Original”>
</script>

The HTML script tag in Table 1 causes a file called “import.js” to be imported to user browser 310 from ASP server 330. This file is a Common Gateway Interface (CGI) program. When executed on ASP server 330, the file import.js generates a second program as output. This output may be transmitted to user browser 310 as a JavaScript source file. This JavaScript source file may correspond to the service resource in step 3 above. An example of the output program generated by import.js according to one embodiment of the invention is shown in Table 2. The JavaScript program shown in Table 2 takes advantage of URL munging. This program causes user browser 310 to examine the JavaScript variable “document.location.href” to determine whether there is munged data present in the URL of the Web page in which the HTML script tag is found. If munged data is present, this munged session data is passed to ASP server 330 using a second HTML script tag. In this example, the second HTML script tag imports a dynamically-generated JavaScript program called “results.js” to user broswer 310.

TABLE 2
Output from import.js

if(/\?(.*&)?term=[\hat{ }&]/.test(document.location.href)) {
document.write(‘<’+‘script src=“http://my.jittersearch.com/
results.js?referrer=’ +
escape(document.location.href) +
‘&username=cswww&form=Standard&results=Original”><‘+’/script>’) ;
}
else {
document.write(

‘<’+‘form action=“”>\n’ +
‘<’+‘input type=“text” name=“term”>\n’ +
‘<’+‘input type=“submit” value=“Search”>\n’ +
‘<’+‘/form>’

) ;
}

The functionality of the JavaScript examples shown in Tables 1 and 2 need not be achieved by using two separate JavaScript programs. A single static JavaScript program may achieve the same functionality. In any case, the process of retrieving munged data from a given URL is the same. In a preferred embodiment the process may be decomposed into two steps merely for the convenience of the customer. In this embodiment the customer need only add the single line of JavaScript shown in Table 1 to Web pages wherein the customer desires the hosted service. This embodiment eliminates the need for the customer to understand and implement an extensive software program to enjoy the functionality of the hosted service provided according to the present invention.

In one embodiment of the invention, default service information such as a blank search form may be displayed in step 2 of the remote URL munging method without requesting any services from ASP 330. In this case, default service information may take the place of the instruction in step 2. The default service information may contain a search form with a “Submit” button that is linked to customer server 320. Clicking on the “Submit” button may initiate the request described in step 5. In such a variation, the data exchange of steps 3 and 4 of the method need not occur.

In other embodiments of the invention the process of retrieving munged URL data may be implemented using a compiled language other than JavaScript. In one embodiment of the invention this compiled language is Java. Interpreted languages other than JavaScript, such as VBScript, may also be used.

The output from the example file import.js shown in Table 2 is one embodiment of a remote URL munging technique. As can be seen in the example in Table 2, the output program in this case may not import results.js unconditionally. Instead, the program first determines whether session variables, for example, search terms, are present that actually need to be processed. In some cases, the hosted service is provided without processing any session data. If no session data needs to be processed then the hosted service is provided more rapidly. Therefore, execution of steps 5 through 8 above is conditional upon the indication of user input found in munged URL data.

When the example output program in Table 2 determines that munged search request data is present, the example output program requests the file results.js from ASP 330. This request corresponds to the service resource request of step 7 above. As noted in step 7, user browser 310 may extract session data that was munged into the URL of the Web page sent in step 6 and send that session data to ASP server 330 simultaneously with the Web page request. The session data may be sent to ASP server 330 using a query string. ASP server 330 may then decode the extracted session information using URL munging technology. This process is computationally trivial because the JavaScript program generated by import.js has provided the munged URL. In one variation, user browser 310 may parse session information before transmitting the data to ASP 330.

As noted in step 8 above, a service resource may display hosted application service information directly within the Web page being loaded in step 6. In one embodiment, this service resource file may be a CGI residing on ASP server 330 called results.js. This service resource sends JavaScript code that dynamically generates the hosted service to user 310. This JavaScript code may invoke the “document.write( )” method to transparently and seamlessly integrate the service into the customer's Web page. In one variation, document.write may be invoked several times to print search results onto the Web page being loaded in step 6. In another variation, the service resource may be an HTML object embedded within the Web page of step 6 and displayed for user 310.

In some embodiments of the invention, the hosted service may provide hypertext links that are written into the Web page being loaded in step 6. For example, the search results page of a hosted site search engine may contain links to the next or the previous pages of search results. When creating these links, the JavaScript code of step 8 munges the URLs associated with these links. The session data with which the URLs are munged reflects any changes in state associated with the links. The static portion of the URL stays the same. Thus, the same Web page that is loaded in step 6 above may be loaded again as a user follows these links. The hosted service that appears on that Web page, however, reflects the changes in state that have occurred. This is possible because session information has been preserved by munging changed session variables each time the page is loaded.

FIG. 4 is a screen shot 400 of one exemplary embodiment of hosted service results displayed within user browser 310. The screen shot 400 shows a Web page 410 generated by customer server 320. The area 420, delineated by a dashed line, is the area into which hosted services 430 may be written by the service resource of ASP 330. In this embodiment, hosted services 430 correspond to search results written by the service resource in step 8 of the remote URL munging method. Using the remote URL munging method, the URL of the ASP 330 never appears in the location bar 440 of user browser 310. User 310 is unaware that the services that appear to be provided by customer 320 are in fact hosted services that are provided by ASP 330.

The remote URL munging method completely integrates hosted services 430 into Web page 410 of customer 320 at the user site 310. Advantageously for customer 320, the result 400 may be obtained without user 310 being directed to ASP server 330.

Cookies Method

In one embodiment of the invention, cookies are used to store session information between user requests for information. The session information may include any dynamic data. The same types of session data that are retained using URL munging can also be stored using cookies. In various embodiments of the invention cookies are used to store a session handle (which references a larger store of data on the server), a unique identifier for a user, or a flag indicating whether the user has visited a particular Web site before.

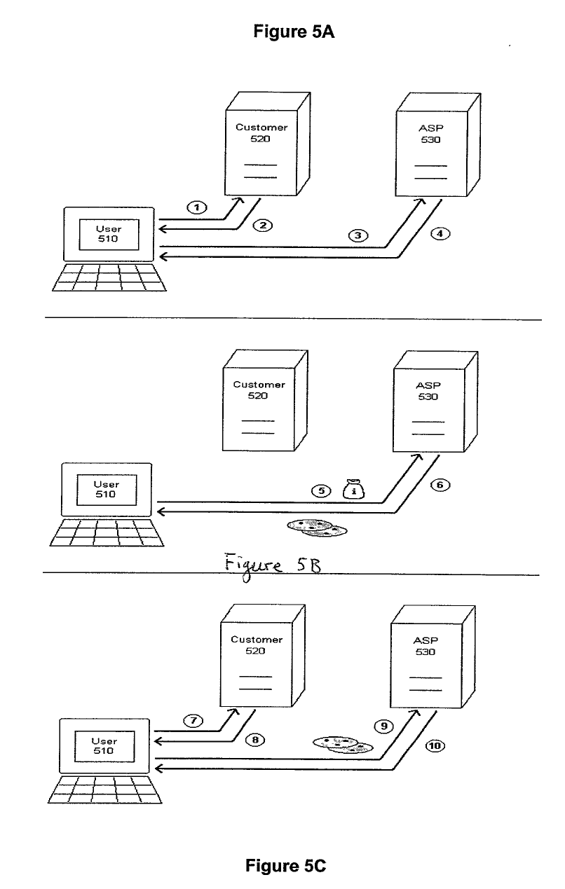

FIGS. 5A-C illustrates the flow of data in an embodiment of the invention that uses cookies and remote URL munging. Each of the circled numbers in FIG. 5 corresponds to a numbered step below. The lines in FIG. 5 represent lines of communication. The arrows show the direction in which data travels.

Downloading a Service Request Form—

1. User 510 makes a request for a customer document, for example, a Web page, from the customer server 520. For example, in one embodiment of the invention, user 510 may click on a link that says, “Search This Site” in step 1. In this example, user browser 510 will then send a request to customer server 520 requesting, for example, a Web page associated with the link.

2. Customer server 520 may then respond with a Web page. This Web page may be static. The Web page in this example may have embedded within its source an instruction for user browser 510 to import a service resource from ASP server 530. This instruction may be, for example, an HTML script tag that instructs user browser 510 to import a JavaScript source file from ASP server 530. In one variation, this Web page may be retrieved from a local cache rather than downloaded from customer server 520.

3. As user browser 510 is interpreting the Web page of step 2, user browser 510 may encounter an instruction to import a service resource from ASP server 530. This instruction may be, for example, an HTML tag that causes a JavaScript source file to be imported from ASP server 530. When user browser 510 encounters this instruction, user browser 510 may make a request for a service resource on ASP server 530. The service resource requested may be, for example, a JavaScript resource. The third arrow in FIG. 5 represents this request. Static information may be sent along with this request. Static information may include a customer identifier or a code indicating the type of service that is being requested.

4. Upon receiving the request of step 3, ASP server 530 may create a service resource. This service resource may be, for example, a JavaScript source file. The service resource may display hosted application service information directly within the Web page being loaded in step 2. This information may comprise a customized splash screen, default information, an HTML search form, and/or a poll or questionnaire. In a preferred embodiment of the invention this information may contain a search form with a “Submit” button that is linked to ASP server 530.

Requesting a Service—

5. User 510 may enter information to be submitted to ASP server 530. For example, user 510 may fill out the search form by entering a search query to be submitted to ASP server 530. User 510 may then initiate an action to send the search query. For example, this action may be the click of a “Submit” button. In this case, the action initiated by clicking “Submit” on this form has been coded to request a Web page from ASP server 530. In step 5, dynamic information “i” may be passed to ASP server 530 along with this request. Dynamic information may include, for example, the keywords being searched or unique identification of the Web user. This dynamic information may be encoded into a query string, a cookie, or an HTTP message body.

6. ASP server 530 may then respond to the request of step 5 with a redirection request to send user browser 510 back to a Web page on customer server 520. For example, user 510 may be redirected back to the same Web page of customer 520 that was loaded in step 2. At the same time or approximately the same time, ASP server 530 may send a cookie to user 510. This cookie contains session data that will later be used to identify or distinguish this user.

Downloading the Service Results—

7. User browser 510 may then request the Web page from customer server 520 that was referenced by the redirection in step 6. The redirection request may be executed so quickly that the user is unlikely to detect that he has visited ASP server 530 at all.

8. Customer server 520 responds with a Web page. This Web page may be, for example, the same Web page as was loaded in step 2. This Web page may be static. The Web page may have embedded within its source an instruction that directs user browser 510 to import a service resource from ASP server 530. This instruction may be, for example, an HTML script tag that instructs user browser 510 to import a JavaScript source file from ASP server 530. This Web page may be retrieved from a local cache rather than downloaded from customer server 520.

9. As user browser 510 is interpreting the Web page of step 8, user browser 510 encounters the instruction to import a service resource from ASP server 530. This instruction may be, for example, an HTML tag that causes a JavaScript source file to be imported from ASP server 530. When user browser 510 encounters this instruction, user browser 510 may then make a request for a service resource on ASP server 530. The service resource requested may be, for example, a JavaScript resource. The ninth arrow in FIG. 5 represents this request. Browser 510 may then regurgitate the cookie from step 6 back to ASP server 530. In this way, session information is sent along with the service resource request. This session information may include, for example, a customer identifier or a code indicating the type of service that is being requested.

10. ASP server 530 may use the cookie regurgitated in step 9 to determine the status of user 510. This status may be used to provide an interactive service. Upon receiving the request of step 9, ASP server 530 may create a service resource, similar to step 4 above. In one variation, this service resource may be a JavaScript source file. The service resource may then print hosted application service information directly into the Web page being loaded in step 7. ASP server 530 may respond to the user's request in step 9 by sending this file. This file may contain, for example, new information not sent to the user in step 4.

The cookies method may be used to provide at least two different types of services. A first type of service is a generic service. In a generic service the data retained by cookies is not unique to an individual user but rather to a category of users. In other words, everyone in the category identified by the cookie gets the same service. Examples of two generic cookie categories are those who have visited a particular Web page before and those who have not.

A second type of service in which cookies are used is an interactive service. Interactive services are services that dynamically respond to user input. An example of this type of service is a hosted site search engine. A hosted site search engine may use cookies to store session data as noted in the description of FIG. 5. In one embodiment of the invention, a hosted site search engine uses cookies to keep track of keywords for which each user is searching. Interactive services differ from the generic services because the latter are not responsive to dynamic user input.

The system and method described above give rise to a unique method of providing network services over, for example, the Internet. The invention is equally applicable to other types of networks. Using the business method of the present invention, an Application Service Provider (ASP) distributes the tool online using servers controlled by the ASP. In one embodiment, source code and object code for the invention may not be accessible to anyone except for ASP employees. Customers may be charged, for example, a monthly subscription fee for the service. The monthly fee depends on the amount of computing resources consumed by the particular customer's usage. Several product types of varying complexity are available to customers.

The business method of the present invention allows a customer to offer hosted application services to its users. According to the method, customers need not install and maintain costly application service hardware and software. The service may be provided at a location different from the customer location. Advantageously, Internet and other network users are unaware that the application service is provided remotely because application service information is seamlessly integrated into customer documents. This allows, for example, a user to access application service information using a Web browser that is directed to the customer address rather than to an application service provider address.

Throughout this specification, the term ASP has been used to indicate any third party that provides services over a network. While one embodiment of the invention comprises a search engine, the invention is not so limited. Other embodiments of the invention contemplate hosted services that are not search engines but that may require state information. By way of example only, these services may include financial services, polling services, tracking services, advertising services, messaging services, weather services, news services, gaming services, etc.

Examples in the steps above that are application-specific (e.g., searching examples) are merely illustrative of the novel technology of the invention. The invention may be practiced with any hosted application service. In one embodiment of the invention, a poll questionnaire or a splash screen could be provided instead of a search form. Instead of entering search keywords, the user may enter a vote in a poll or select symbols of stocks the present value of which he wishes to be displayed. The invention is readily adapted to any type of interactive service.

By way of example, in one embodiment of the invention an ASP provides real time stock quotes that appear on a customer brokerage's Web page. Web users browsing the brokerage's Web site view the stock quotes provided by the ASP as if the stock quotes were provided by the customer brokerage. The brokerage purchases the hosted stock quote service from the ASP.

In a preferred embodiment of the invention, remote URL munging is used to provide a site search engine for the customer's Web site. In this embodiment, an ASP implements a business method using a system that comprises three components: an administrative interface for customers, a spider, and a hosted service.

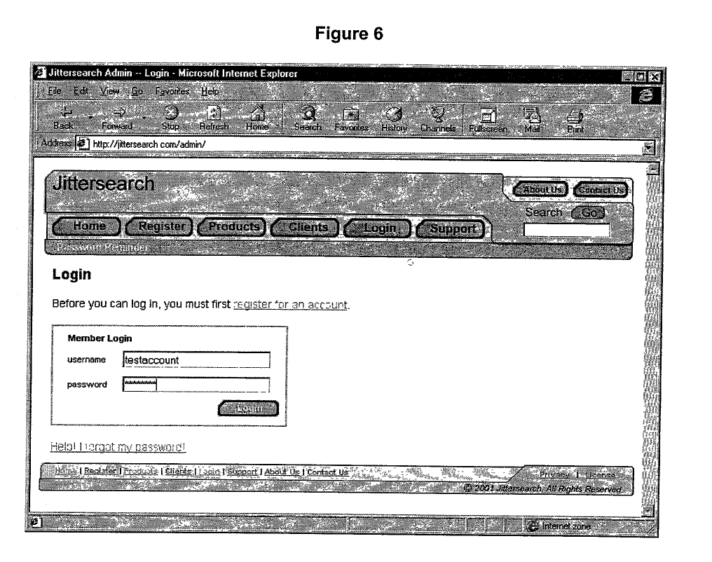

The first component of the system is the administrative interface for customers of ASP 330. To sign up for a user account, customer 320 may visit a Web site that hosts the administrative service. The administrative interface may comprise, for example, a login Web page. A login page of one embodiment of the invention is shown in FIG. 6. In contrast to the extensive effort to set up other search engines, this simple registration process may take less than three minutes.

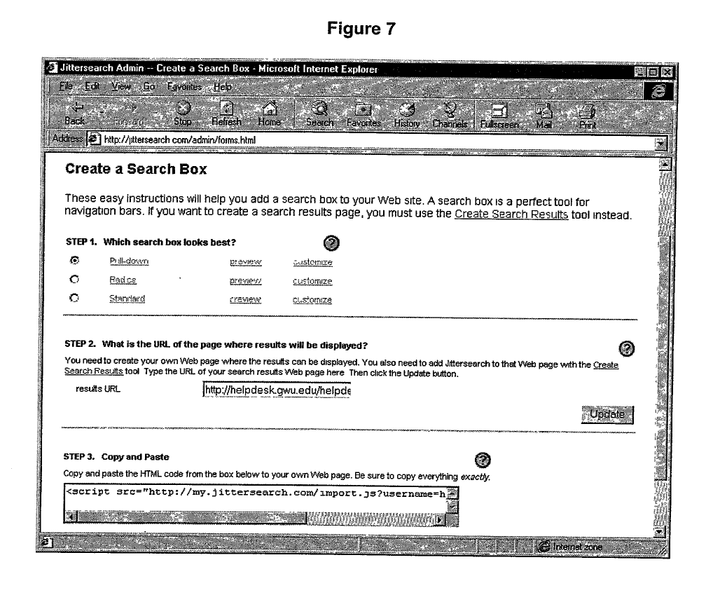

Using the administrative interface, customer 320 has the option of customizing the visual layout and complexity of the hosted service forms. In one embodiment of the invention, the hosted service forms comprise search forms and search results. The administrative interface includes online tools to make hosted service form customization simple. By way of example only, one variation of a customization tool Web page is shown in FIG. 7. As shown in FIG. 7, customer 320 may select, for example, from a variety of search box designs. Using an administrative interface customer 320 may supply the URL of the site on which hosted service results (e.g., search results) may be displayed. Through an administrative interface customer 320 may be given a line of code to copy and paste into its Web pages. This code may be, for example, a line of HTML code as shown in the “Step 3” field of FIG. 7. Customer 320 need only paste this code into a Web page where customer 320 desires a search form to appear. No other search engine software needs to be installed on the customer's machine. In another embodiment of the invention, an administrative interface is used to register for services other than hosted site search engine services.

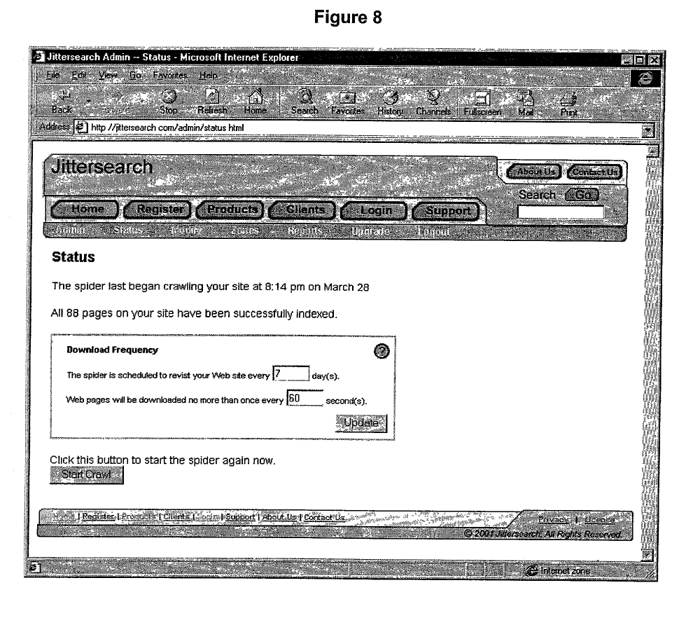

In a search engine embodiment, the invention comprises a second component called a spider. The exemplary Web page shown in FIG. 8 relates to this second component. A spider (also known as a robot) crawls through the customer's entire Web site, downloading and storing information for every Web page therein. The spider uses the hyperlinks and other HTML cues to help it find all the pages on the site. The spider begins indexing the customer's Web site as soon as the customer subscribes to the service. Only textual content is stored. An index of the site is maintained in compressed form in a database on the ASP's Internet servers.

A spider periodically may return to a site that has subscribed to search engine services in order to update an index database. By way of example, customer 320 may customize the frequency of these updates or initiate an update. FIG. 8 illustrates one variation of an interface customer 320 may use to interact with a spider component. In an embodiment of the invention wherein the service provided by the ASP is a service other than a hosted site search engine, the inventive system may not include a spider.

The third component of the system is a hosted service. In one embodiment of the invention the hosted service may be a hosted site search engine. In this embodiment, the ASP server may generate search form components or return search results for Web browsers. Search forms may be included in any of the Web pages on the customer's site. In one embodiment, a search form is embedded in one of these pages using a line of HTML code. Search forms or other application services may be customized for each customer or selected from a predetermined library of options. In one embodiment, the code may use, for example, JavaScript to contact the ASP servers. The code may also identify the user and the type of searching that the user desires. The method of distinguishing Web users from one another may be based, for example, on a novel use of JavaScript discussed herein.

In a search engine embodiment of the invention, the search results may be seamlessly integrated within any Web page. This allows a customer that has already created Web pages containing its own branded content to integrate searching capabilities into existing Web pages. To a user viewing the Web page, the search results do not appear to have originated from a different server than the rest of the Web page. The visual layout of the results may be customized. The ability to seamlessly incorporate the search results into a customer's Web page is facilitated by the inventive coding discussed herein.

In one embodiment of the invention the hosted service is an inventory search engine. The inventory search engine uses restrictive search techniques that return products being sold on the site rather than site Web pages. For example, a Web user who wants to find and then purchase a book written by “Ellison” and categorized as a “paperback” would use an inventory search. In this embodiment, an ASP may use XHTML technology to identify the products a customer retails online. In another embodiment of the invention, an ASP uses SQL queries to identify the products that a customer retails online. Like the site search engine, the inventory search engine appears to the user as if it were tailored for the customer's unique site. However, the ASP need not worry about customizing the search engine appearance for a particular customer; the ASP provides a one-size-fits-all solution for use by a wide variety of customers.

Another embodiment of the invention features a thematic search engine as the hosted service. A thematic search engine searches hundreds of Web sites, each of which emphasizes the same topic. Thematic search engines offer extra value to Web sites that want to position themselves as authoritative portals for their specific niches. The thematic search works by finding pages that contain predetermined keywords and ignoring pages that appear to be off topic.

As previously mentioned, the invention is not limited to hosted search engines. The invention contemplates using other application services as the hosted service component. These services may fall anywhere on the spectrum from completely static Web pages to fully dynamic and interactive Web pages. By way of example only, hosted services may include dynamic services such as real-time stock quotes or weather reports. Hosted services may also include interactive pages used for surveying and polling.

Distribution of the inventive technology described herein follows the application service provider model. An ASP provides a hosted service online via Internet servers operated by the ASP. Customer Web sites utilizing the hosted service may be charged, for example, a monthly fee. Customer Web site managers can subscribe to the hosted service by registering for an account using the administrative tool. New accounts can be activated without human intervention. ASP servers are always ready to service a search query or other hosted service request for users of customer account Web pages. These servers comprise the entire vehicle for product delivery. Extensive software programs need not be distributed to customers. Neither source code nor object code of the actual search engine is accessible to anyone outside of the ASP.

Customer subscription rates may depend on the amount of computing resources needed in the product that the customer chooses. In one embodiment of the invention, a customer may choose from three varying product types. For example, a customer may choose from a Community version, a Pro version, and a Corporate solution.

The Community version of a hosted service may be a means for viral advertising. Button ads appear in the hosted service results. This product is positioned to be popular with low budget Web sites. For example, the Internet contains thousands of low-budget Web sites that do not have access to any site search solution. A Community site search engine embodiment of the invention may bring search capabilities to these sites. No human labor is necessary for Community account maintenance. The features offered in the Community product are easy to use, so very little technical support need be provided to Community customers. The Community product is as powerful as many free site search engines. It also produces more professional results than existing solutions because hosted service results are fully integrated into the customer's own Web pages.

The Pro product is suited for customers desiring a significant online presence. The formats of hosted service results may be tailored for each customer. In one embodiment, the customer's Web site can be divided into separate categories called zones so that Web users have the option of restricting their search to the zones that interest them.

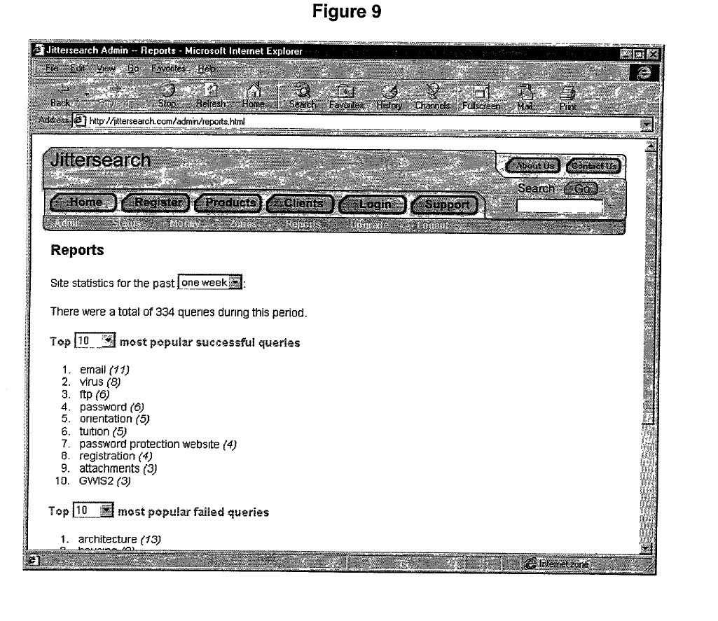

In another embodiment, customers of Pro accounts may have access to reports on the keywords for which users are searching most frequently. An example of a search report of one embodiment of the invention is shown in FIG. 9.

In a further embodiment the Pro solution may offer full-text searching. Full-text searching may allow Web users to perform search queries on contiguous word phrases rather than just individual words. For example, a full-text search using an exact query for “robots exclusion” would find all documents that contain that exact phrase. Non-exact queries find documents that contain both the word “robots” and the word “exclusion,” whether or not the words are adjacent to each other. Full-text searching also may allow the user to see identified keywords in context, such as, “ . . . an evaluation of the Standard for Robots Exclusion identifies some of its problems . . . ” Evaluating search results in context may allow the user to evaluate the relevancy of each result without having to visit each page individually.

A Corporate embodiment of the invention may include all the features that an ASP has to offer. Any size of Web site can subscribe to a Corporate account. In an embodiment of the invention wherein the hosted service is a site search engine, robust statistical techniques may be employed on Corporate accounts to increase the precision of keyword searches. A customer is able to define synonyms and domain-specific dictionaries to increase the recall capacity of a customized search engine. The Corporate embodiment may be easier to use and allow for more customization than other known search products.

In variation of the invention wherein the hosted service is an inventory search engine, only customer products are searched, not Web pages. E-commerce retailers may prefer this embodiment. In this embodiment, the customer uses special XHTML codes to identify searchable products on the customer's Web pages. These codes will inform a spider which text is relevant to inventory searching and which text to ignore. Relevant inventory text may include the product name, description, style, color, price, quantity in stock, etc. In one embodiment of the invention, a customer can store product information in a SQL database. Each customer can define different product characteristics to be displayed to Web users.

In one embodiment of an inventory search engine, a customer may create a searchable index of downloadable software. The customer defines product-specific characteristics such as “Name,” “Description,” “Platform” and “Size.” By way of example, in this embodiment Web users are able to search for a software application written for a specific platform or having a specific name.

In another embodiment of the invention, the hosted service may provide the capability to search an index of electronics equipment. In this embodiment of the invention the electronics merchant may customize the search results so that an “Add this to your shopping cart” button appears along side of each product name.

The remote URL munging technique includes several novel features. For example, in one embodiment of the invention, a customer may incorporate search results into any Web page with only one line of HTML code. Additionally, the customer will enjoy total integration between search results and the customer's own branded Web pages. Search results appear to be part of the customer's own branded Web site and not from a remote service. Further, through an embodiment of the invention that uses XHTML technology, small customers are empowered with product-specific search capabilities for the first time. These technologies enhance the overall user experience. Remote URL munging can be activated effortlessly in the present embodiment of the invention. This ease of use saves Web designers time and money.

Several online services distribute site search engine technology for free. These services earn revenue through banner advertisements that are displayed to Web users that use the search engine. This revenue stream allows companies to offer basic search engine features to clients who do not want to pay for a more sophisticated product.

The present invention provides a business method that surpasses these advertising revenue-driven business models. Using a hosted site search engine embodiment of the present invention, an ASP is in the business of selling search engines, not in the business of selling advertising. This allows the ASP to focus on development of its core technology instead of peripheral marketing strategies.

This business method provides other revenue-generating features. Even without a subscription distribution network, an ASP may still sell the novel source code of the present invention in the business-to-business market. In one embodiment of the invention, the ASP may also sell customer profiles or user profiles generated through the practice of the invention. The novel features of the invention described herein give those who practice it a distinct competitive advantage by allowing a customer to completely integrate hosted application services into their own Web pages without having the user leave the customer's web site.

The invention disclosed herein may be practiced across a variety of network platforms using a variety of protocols and programming languages. For example, in one embodiment of the invention Uniform Resource Indicators are munged instead of URLs. In another embodiment of the invention URLs may be munged using techniques that do not require a query string. In other embodiments of the invention munged data may be encoded and decoded using a variety of techniques known to those of skill in the art. In further embodiments of the invention data is munged, coded, or decoded by either the user, the ASP, another computer, or any combination thereof using the inventive system and method described herein.

Some embodiments of the invention may use relatives of HyperText Markup Language (HTML). In one of these embodiments the invention is practiced using Extensible Markup Language (XML). The invention is not limited to implementation using JavaScript. The inventive system and method may be practiced using other computer languages.

One embodiment of the invention contemplates use on the World Wide Web, while another embodiment of the invention contemplates use on other parts of the Internet. Still another embodiment of the invention is adapted for use on any type of network (e.g., an intranet). While one embodiment of the invention may use a Web browser, another embodiment of the invention may use other client devices that request services over a network.

As will occur to those of skill in the art, the steps of the inventive method may vary in order, repetition, and omission. For example, in one embodiment of the invention a Web browser may be redirected several times in the course of requesting a hosted service. One embodiment the inventive system and method may spread the JavaScript logic across more than one file by decomposing the method into substeps. In some embodiments of the invention, one or more requests may not be made because the files have already been downloaded and cached by the user. In other embodiments of the invention a gateway or other intermediary handles some parts of the process in a way that is invisible to the user.

In other embodiments of the invention cookies may be sent and received at several additional points during the process outlined herein. The invention contemplates using multiple services at the same time or providing one service using multiple servers. As will occur to those skilled in the art, known methods for managing network sessions could be combined with remote URL munging within the scope of this invention. For example, some embodiments of the invention incorporate features from each method disclosed herein. By way of illustration, one embodiment of the invention posts HTML form variables to the ASP server as described in the cookie method but records session data using URL munging as described in the remote URL munging method.

While the above description is set forth in specific detail, these details should not be construed as limitations on the scope of the invention but rather as an exemplification of embodiments thereof. Other variations that remain within the spirit and scope of the invention may occur to a skilled artisan from the disclosure herein.

I claim:

1. A method for providing a hosted application service, comprising the step of:
providing an instruction to be embedded in a customer document wherein said instruction retrieves hosted service information from an application service provider system and seamlessly integrates said information into said customer document at a user location.

2. The method of claim 1, wherein said customer document does not reside on said application service provider system.

3. The method of claim 2, wherein said application service provider system includes a server, said customer document is an HTML Web page, and said user location comprises a user Web browser.

4. The method of claim 3, wherein said instruction retrieves hosted application service information by initiating a service resource request from said application service provider server.

5. The method of claim 4, wherein said instruction further directs dynamic information to be passed to said application service provider server during said resource request.

6. The method of claim 5, wherein said dynamic information is passed to said application service provider server using a query string.

7. The method of claim 5, wherein said dynamic information is passed to said application service provider using a cookie.

8. The method of claim 5, wherein said hosted application service information is determined in response to said dynamic information.

9. The method of claim 8, wherein said hosted application service information comprises a link to a document residing on a customer server.

10. The method of claim 9, wherein said link is coded so as to preserve dynamic information.

11. The method of claim 10, wherein said link is coded so as to preserve dynamic information using session variables.

12. The method of claim 11, wherein said link is coded so as to preserve dynamic information using URL munging.

13. The method of claim 12, wherein said instruction is an HTML tag.

14. The method of claim 13, wherein said service resource is a JavaScript source file.

15. The method of claim 14, wherein said link is an HTML form.

16. The method of claim 15 wherein said hosted application service comprises a search engine.

17. The method of claim 8, wherein said hosted application service information comprises a second instruction that retrieves new hosted service information from an application service provider server and integrates said new information into said customer document at said user location.

18. A system for providing a hosted application service comprising:
an instruction to be embedded in a customer document wherein said instruction retrieves hosted service information from an application service provider system and integrates said information into said customer document at a user location.

19. The system of claim 18, wherein said application service provider system includes a server, said customer document is an HTML Web page that does not reside on said application service provider system, and said user location includes a user Web browser.

20. The system of claim 19, wherein said instruction further directs dynamic information to be passed to said application service provider server and said hosted application service information is determined in response to said dynamic information.

21. The system of claim 20, wherein said hosted application service information comprises a link to a document residing on a customer server and said link is coded so as to preserve dynamic information using URL munging.

22. The system of claim 20, wherein said HTML Web page comprises a link to a document residing on a customer server and said link is coded so as to preserve dynamic information using URL munging.

23. A system for providing a hosted application service comprising:
an administrative interface;
an instruction to be embedded in a customer document, provided via said administrative interface; and
a hosted service provided in response to said instruction.

24. The system of claim 23, wherein said instruction retrieves hosted service information from an application service provider system and integrates said information into said customer document at a user location.

25. The system of claim 24, wherein said administrative interface comprises customization tools adapted to customize the appearance of said information within said customer document.

26. The system of claim 25, wherein said administrative interface comprises a customer enrollment form.

27. The system of claim 26, wherein said hosted application service comprises a hosted site search engine.

28. The system of claim 27, wherein said system further comprises the step of providing a robot to index a customer Web site.

29. A system for providing a hosted application service comprising:
means for providing, upon request of a user, hosted application service information from a remote location, said information being integrated into a customer document at a user location such that it appears to the user that the information and the customer document originated from a customer system.
